(19) United States
(12) Patent Application Publication
(10) Pub. No.: US 2007/0037920 A1
(43) Pub. Date: Feb. 15, 2007

(54) Primer composition

(75) Inventors: Annemarie Kulling, Winterthur (CH); Michael Goeldi, Winterthur (CH)

Correspondence Address: OLIFF & BERRIDGE, PLC, P.O. BOX 19928, ALEXANDRIA, VA, 22320, US

(73) Assignee: Sika Technology AG, Baar (CH)

(21) Appl. No.: 11/489,575

(22) Filed: Jul. 20, 2006

(30) Foreign Application Priority Data
Aug. 12, 2005 (EP) 05107445.8

(51) Int. Cl. C08G 18/42

(52) U.S. Cl. 524/500

(57) ABSTRACT

The present invention relates to primer compositions comprising at least one binder which contains isocyanate groups and is prepared from a mixture of an amorphous polyester resin A which is solid at room temperature and contains at least one OH group and from at least one polyisocyanate B of the formula (I). The ratio of solid polyester resin A and polyisocyanate B is employed in this case in a ratio such that the stoichiometric ratio of the NCO groups to the OH groups is situated in the range between 50:1 and 100:1 and/or the weight ratio of polyester resin A to polyisocyanate B has a value between 1.6 and 0.75. The primer compositions are notable in particular for effective adhesion to plastics and paints, especially automobile paints.

### TECHNICAL FIELD

The present invention relates to the field of primer compositions.

### BACKGROUND ART

Adhesive bonding is a widely used joining technology. Due to the large number of possible substrates which are bonded to one another, there are at regular intervals substrates which are unable to develop any adhesion, or sufficient adhesion, with certain adhesives. In order to promote the adhesion of adhesives and sealants to such substrates, specific primers have been used for a relatively long time already.

Plastics and painted substrates are very important substrates for industrial manufacture. Due to the different kind of paints, painted surfaces in particular are a substrate of this kind which is known to be difficult to be bonded. Particularly critical are the newer generations of automotive paints in combination with one-component polyurethane adhesives or sealants.

Attempts have therefore be made to develop pretreatment methods for increasing the adhesion to paints. Thus U.S. Pat. No. 4,857,366 discloses an undercoat for paints containing p-toluenesulphonic acid and WO-A-99/31191 discloses a solution of a hydrocarbyl-substituted aromatic sulphonic acid in alkyl alcohol, or in an aromatic or alkyl aromatic solvent, which are said to lead to an improvement in paint adhesion.

On the other hand, WO-A-2004/033519 discloses primer compositions which contain a polyurethane prepolymer and also a catalyst system, which are obtainable from a bismuth compound and also an aromatic nitrogen compound, and lead to a sharp improvement in paint adhesion. US-A-2003/0084995 discloses a primer composition which comprises a resin and also a polyisocyanate, a catalyst and also a solvent. A range of possible substances are mentioned as the resin and polyisocyanate. It is further disclosed that a composition of this kind can be employed as a primer for plastics such as PVC, polyurethanes, polyolefins, polystyrenes and EPDM.

### DISCLOSURE OF INVENTION

It is an object of the present invention to provide a new primer which strongly promotes the adhesion of polyurethane adhesives and sealants to plastics and paints, especially to paints.

Surprisingly it has emerged that very specific primer compositions according to Claim 1 produce a sharp improvement in the adhesion of polyurethane adhesives to paints and plastics.

### BEST MODES FOR CARRYING OUT THE INVENTION

The present invention relates to primer compositions which comprise a specific binder containing isocyanate groups.

This specific binder is prepared from a mixture of an amorphous polyester resin A which is solid at room temperature and contains at least one OH group and of at least one polyisocyanate B of the formula (I).

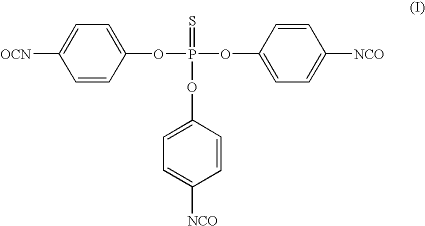

The polyisocyanate B of the formula (I) is also referred to as tris(p-isocyanatophenyl) thiophosphate. It is employed preferably as a solution in a solvent, in particular in an ester. A particularly preferred form is the form in which it is available commercially as Desmodur® RFE from Bayer. According to details from Bayer, Desmodur® RFE is a 27% strength solution of tris(p-isocyanatophenyl)thiophosphate in ethyl acetate.

The ratio of solid polyester resin A and polyisocyanate B is used in this case in a ratio such that the stoichiometric ratio of the NCO groups to the OH groups is situated in the range between 50:1 and 100:1 and/or the weight ratio of polyester resin A to polyisocyanate B has a value of between 1.6 and 0.75, in particular between 1.2 and 0.8. In particular the stoichiometric ratio of the NCO groups to the OH groups is situated in the range between 50:1 and 100:1 and the weight ratio of polyester resin A to polyisocyanate B has a value of between 1.6 and 0.75, in particular between 1.2 and 0.8.

In particular the weight ratio of polyester resin A to polyisocyanate B is approximately 1:1.

The polyester resin A contains at least one, preferably at least two, OH groups, is amorphous and is solid at room temperature. It has a melting point (melt flow) of more than 140° C., in particular between 150 and 160° C., as measured by the ring & ball method). On the other hand the polyester resin A at 25° C. has a Shore D hardness of preferably between 70 and 85, in particular between 75 and 85, more preferably between 77 and 82.

The polyester resin A suitable are prepared in particular from at least one dicarboxylic acid and at least one glycol. The polyester resin A preferably has a molecular weight of more than 12,0000 g/mol, in particular between 15,000 and 40,000 g/mol. With further preference the polyester resin A has an OH number between 2 and 9, in particular between 3 and 6, mg KOH/g. With further preference the polyester resin is an aromatic polyester resin.

The polyester resin A typically has the following structure of the formula (II)

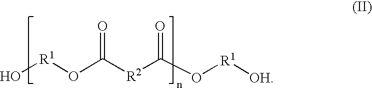

The radicals R¹ and R² here represent, independently of one another, divalent organic radicals, and n indicates the number of repeating units.

Particularly preferred polyester resins A are those which are sold within the 2000 series of the product series Vitel® from Bostik. These are, in particular, Vitel® 2100, Vitel® 2180, Vitel® 2190, Vitel® 2000, Vitel® 2200, Vitel® 2300 and Vitel® 2700. Particular preference is given to Vitel® 2200, and to Vitel® 2200B.

The binder containing isocyanate groups is prepared by mixing at least the polyisocyanate B of the formula (I) and the polyester resin A containing at least one OH group. Mixing takes place such that the stoichiometric ratio of the NCO groups to that of the OH groups is situated in the range between 50:1 and 100:1 and/or the weight ratio of polyester resin A to polyisocyanate B amounts to a value of between 1.2 and 0.8.

It can therefore be assumed that what is being prepared is essentially an adduct of two molecules of polyisocyanate B with one molecule of polyester resin A, and therefore an adduct of the formula (III) having four free isocyanate groups

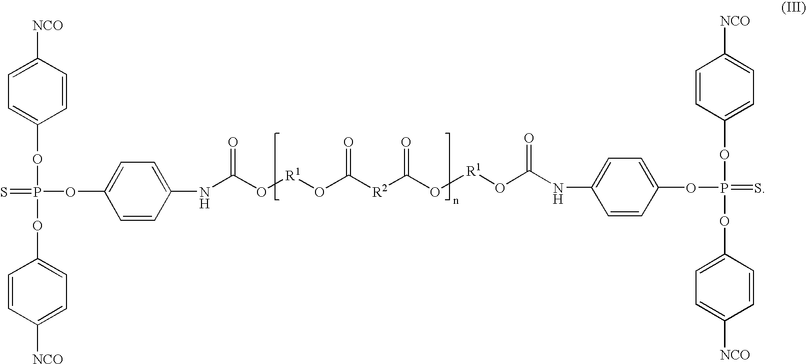

The preparation takes place preferably by initially introducing the at least one polyisocyanate B and adding thereto the at least one polyester resin, preferably in solution in an organic solvent, with stirring and under an inert gas atmosphere. Organic solvents suitable for use if appropriate for dissolving the polyester resin A include, in particular, ketones or esters. Preference is given to methyl ethyl ketone (“MEK”) or ethyl acetate.

In one embodiment the primer composition comprises at least one organic solvent. Preferred solvents are ketones or esters, especially esters, preferably ethyl acetate.

In another embodiment the primer composition comprises at least two organic solvents. Particular preference is given to esters as the one solvent and ketones as a second solvent. The solvents are in particular ethyl acetate in the case of one solvent and a ketone, preferably methyl ethyl ketone, for the other solvent.

It is preferred for the fraction of the binder which is prepared from a mixture of the polyester resin A and from at least one polyisocyanate B to be 10% to 50% by weight, in particular 15% to 30% by weight, based on the weight of the primer composition.

In one preferred embodiment a fraction of the polyisocyanate B is replaced stoichiometrically by at least one polyisocyanate B′ and/or by at least one polyisocyanate B″ and/or by at least one polyisocyanate B′″. It is important in this context that only a part of the polyisocyanate B is replaced, and that, therefore, it is not a complete replacement of the polyisocyanate B. The polyisocyanate B′ is an isocyanurate of hexamethylene diisocyanate (HDI), the polyisocyanate B″ is an aromatic polyisocyanate based on tolylene diisocyanate (TDI) and the polyisocyanate B′″ is an oligomeric polyisocyanate of hexamethylene 1,6-diisocyanate (HDI), diphenylmethane diisocyanate (MDI), isophorone diisocyanate (IPDI) and/or tolylene diisocyanate (TDI) or polymethylene polyphenyl isocyanate, in particular what is called crude MDI. The polyisocyanates in question here are preferably polyisocyanates B′ and B″, of the kind sold under the name Desmodur® L 75 and Desmodur® N 3300 commercially by Bayer. Polyisocyanates B′″ are preferably oligomeric polyisocyanates of the kind sold under the name Vestanat® T 1890 by Degussa or Vorante® M580 commercially by Dow.

If in addition to B B′ and/or B″ and/or B′″ are also used as polyisocyanate for preparing the binder containing isocyanate groups, it is advantageous if polyisocyanate B amounts to more than 50% by weight of the weight sum of B, B′, B″ and B′″.

If in addition to B B′ and/or B″ and/or B′″ are also used as polyisocyanate for preparing the binder containing isocyanate groups, it is advantageous if the weight ratio of polyester resin A to the weight sum of B, B′, B″ and B′″ has a value of between 1.6 and 0.75, in particular between 1.2 and 0.8.

In one preferred embodiment the primer composition comprises at least carbon black as filler. It is preferred for carbon black to be present in the primer composition in an amount of 1% to 20% by weight, in particular of 2% to 15% by weight, based on the weight of the primer composition.

It may very well be advantageous that further polyisocyanates are present in in the primer composition, such as, for example, hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and 1,4-diisocyanate and any desired mixtures of these isomers, 1-isocyanato-3,3,5-tri-methyl-5-isocyanatomethylcylohexane (=isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), tetramethylxylylene 1,3- and 1,4-diisocyanate (TMXDI), 1,3- and 1,4-bis(isocyanatomethyl)cyclohexane, toluene 2,4- and 2,6-diisocyanate (TDI) and any desired mixtures of these isomers, diphenylmethane 4,4′-, 2,4′- and 2,2′-diisocayante (MDI) and any desired mixtures of these isomers, phenylene 1,3- and 1,4-diisocyanate, 2,3,5,6-tetramethyl-1,4-diisocyanatebenzene, naphthalene 1,5-diisocyanate (NDI), 3,3′-dimethyl-4,4′-diisocyanatobiphenyl (TODI), 1-isocyanato-3,3,5-trimethyl-5-isocyanatomethylcyclohexane (=isophorone diisocyanate or IPDI), perhydro-2,4′- and -4,4′-diphenylmethane diisocyanate (HMDI), 1,4-diisocyanato-2,2,6-trimethylcyclohexane (TMCDI), tetramethylene 1,4-diisocyanate, 2-methylpentamethylene 1,5-diisocyanate, 2,2,4- and 2,4,4-trimethylhexamethylene 1,6-diisocyanate (TMDI), dodecamethylene 1,12-diisocyanate, lysine diisocyanate and lysine ester diisocyanate, 1,3- and 1,4-bis(isocyanatomethyl)cyclohexane (BIC), m- and p-xylylene diisocyanate (m- and p-XDI), 1,3,5-tris(isocyanatomethyl)benzene or bis(1-isocyanato-1-methylethyl)naphthalene.

The primer composition may comprise further ingredients, such as catalysts, thixotropic agents, dispersants, wetting agents, corrosion inhibitors, adhesion promoters, especially alkoxysilanes and titanates, UV stabilizers and heat stabilizers, pigments, dyes and UV indicators.

Examples of suitable catalysts include tin catalysts, bismuth catalysts and amine catalysts.

Appropriate tin catalysts include, in particular, organotin compounds such as dibutyltin dilaurate, dibutyltin diacetylacetonate, dibutyltin diacetate, dioctyltin dicarboxylate, mono- or dibutyltin thioesters, and dibutyltin dichloride.

Appropriate bismuth catalysts include, in particular, bismuth carboxylates, especially bismuth tricarboxylates, and also bismuth catalyst systems which are obtainable from bismuth compounds and an aromatic nitrogen compound and are in WO-A-2004/033519. An aromatic nitrogen compound suitable for this purpose particularly is 8-hydroquinoline.

The primer compositions are notable for the fact that they lead to an improvement in the adhesion of adhesives or sealants to plastics and painted surfaces and can therefore be used as primers.

Particularly on the plastics acrylonitrile-butadiene-styrene copolymer (ABS), polymethyl methacrylate (PMMA) and polycarbonate it has been possible to observe effective adhesion.

A painted surface comprehends, in particular, paint-coated substrates such as glass, wood, metals, metal alloys, plastics and also mineral substrates such as concrete, rock or brick.

Particularly important paint includes paints of means of transport, especially automotive paints. The most important paint is automotive paints of the newer generation, especially multiple-bake paints, of which it is known that adhesives, especially one-component moisture-curing polyurethane adhesives or sealants, can give rise to adhesion problems.

The present invention further provides a method of adhesive bonding or of sealing. There are three versions in particular of this method.

In a first version it comprises the steps of
a) applying the primer composition to a first substrate S1 to be bonded or sealed
b) applying an adhesive or sealant to the flashed-off primer composition located on the substrate S1
c) contacting the adhesive or sealant with a second substrate S2.

In a second version it comprises the steps of
a′) applying the primer composition to a first substrate S1 to be bonded or sealed
b′) applying an adhesive or sealant to the surface of a second substrate S2, composed of the same or different material as the substrate S1,
c′) contacting the adhesive or sealant with the flashed-off primer composition which is located on the substrate S1;

In the third version it comprises the steps of
a″) applying the primer composition according to a first substrate S1 to be bonded or sealed
b″) flashing off the primer composition
c′) applying an adhesive or sealant between the surfaces of the substrate S1 and S2.

In all of these version of the method it is possible for the second substrate S2 to be composed of the same or different material as the first substrate S1.

The first substrate S1 is preferably a paint, in particular a painted metal. A painted surface comprehends, in particular, paint-coated substrates such as glass, wood, metals, metal alloys, plastics and also mineral substrates such as concrete, rock or brick.

Particularly important paints include paints of means of transport, especially automotive paints, particularly automotive topcoat materials and cathodic electrocoats. The most important paints are automotive paints of the newer generation, especially multiple-bake paints, of which it is known that adhesives, especially one-component moisture-curing polyurethane adhesives or sealants, can give rise to adhesion problems.

If the second substrate S2 is of a material different to that of S1, the substrate S2 is in particular of glass or ceramic.

In a further embodiment of the method, in the case of the three methods mentioned beforehand, step c) or c′) or c″) is followed by a step d) of curing the adhesive or sealant.

Depending on the adhesive or sealant used, this step may take place immediately after step c) or c′) or c″) or with a time offset.

A variety of different adhesives or sealants can be used. Depending on the use and service location of the bonded or sealed structure, the adhesive or sealant in question may be epoxy resin-based, isocyanate-based, based on (meth)acrylates or based on silane-terminated polymers (“STP”s) or silicones. The adhesives or sealants in question may be, for example, room-temperature-curing adhesives or sealants, hot-melt adhesives (known as “hotmelts”), dispersion-based adhesives or sealants, or pressure-sensitive adhesives.

The adhesive or sealant may be one-component or multi-component. Preferably the adhesive or sealant is one-component.

In particular, however, the systems in question are one-component polyurethane adhesives or sealants. By polyurethane adhesives and polyurethane sealants are meant, here and throughout the present document, adhesives and sealants which comprise prepolymers which contain free isocyanate and/or alkoxy silane groups and contain urethane and/or urea groups. Accordingly the term “polyurethane” embraces not only the conventional polyurethanes but also the silane-terminated polyurethanes which are also known to the skilled person under the term “silane terminated polyurethanes” (“SPUR”).

Besides polyurethanes it is also possible to use alkoxy silane-terminated polymers, of the kind known to the skilled person under the term “MS polymers”, in adhesives or sealants.

The adhesive or sealant is preferably a moisture-curing one-component polyurethane adhesive or sealant. As particularly preferred it is a moisture-curing one-component polyurethane adhesive or polyurethane sealant, in particular a moisture-curing one-component polyurethane adhesive of the kind available, for example, commercially as Sikaflex® from Sika Schweiz AG.

The present invention further provides a bonded or sealed article. These bonded or sealed articles are obtained by a method as has just been described.

The bonded or sealed articles obtained in this way are of diverse nature. In particular they are from the field of industrial manufacture, and with preference they are means of transport, especially automobiles. They may also be surface-mounted components. Surface-mounted components of this kind are, in particular, prefabricated module components which are used as modules on the production line and in particular are mounted or installed by adhesive bonding. These prefabricated surface-mounted components are preferably used in the construction of means of transport.

Examples of a surface-mounted component of this kind is the driver's cab of trucks or of locomotives, or sunroofs for cars.

There are, however, also possible applications in the construction of furniture, white goods, such as washing machines, architectural components such as facings or lifts.

### EXAMPLES

Preparation of Primer Compositions

In accordance with the quantities in Table 1, the polyisocyanate was introduced as an initial charge in the solvent, or a portion thereof, and then, with stirring, the polyester resin, where appropriate in solution in the remainder of the solvent, was added slowly dropwise with stirring, under nitrogen, and stirred for 1 hour during 30° C. The solution was then heated to 40° C. and stirred until the NCO content is constant. For this purpose, any solvents present, dryers (p-toluenesulphonyl isocyanate “TI”), catalyst (dibutyltin dilaurate “DBTL”) and carbon black were introduced into a metal canister which can be sealed tight, glass beads were added, the canister was sealed, and the contents were intimately mixed for 1 hour by means of a Red Devil shaker apparatus.

After the mixing operation, the glass beads were separated off and the primer composition was introduced into a tightly closing aluminium flask. The example REF-7 is simply methyl ethyl ketone.

TABLE 1
Primer compositions.

| | B1-1 | B1-2 | B1-3 | B2-1 | B2-2 | B2-3 | B3-1 | B3-2 |
|---|---|---|---|---|---|---|---|---|
| Methyl ethyl ketone | 10.50% | 9.21% | 8.14% | | | | | |
| Ethyl acetate | 47.95% | 47.71% | 47.71% | 58.27% | 56.87% | 55.82% | 54.07% | 52.72% |
| Desmodur ® RFE | 29.57% | 32.39% | 34.46% | 29.70% | 32.35% | 34.44% | 32.68% | 35.51% |
| Desmodur ® L 75 | | | | | | | | |
| Desmodur ® N 3300 | | | | | | | | |
| Vitel ® 2200B | 10.50% | 9.21% | 8.14% | 10.53% | 9.27% | 8.20% | 11.60% | 10.10% |
| TI | 1.01% | 1.00% | 1.03% | 1.01% | 0.99% | 1.03% | 1.10% | 1.12% |
| DBTL | 0.48% | 0.48% | 0.52% | 0.49% | 0.51% | 0.52% | 0.55% | 0.55% |
| Total | 100.00% | 100.00% | 100.00% | 100.00% | 100.00% | 100.00% | 100.00% | 100.00% |
| Carbon black | | | | | | | 10.12% | 10.13% |
| B | 8% | 9% | 9% | 8% | 9% | 9% | 8% | 9% |
| A | 10% | 9% | 8% | 11% | 9% | 8% | 11% | 9% |
| A + B | 18% | 18% | 17% | 19% | 18% | 17% | 19% | 18% |
| A/B | 1.31 | 1.05 | 0.87 | 1.31 | 1.06 | 0.88 | 1.31 | 1.05 |
| [NCO]/[OH] | 60 | 75 | 90 | 60 | 75 | 90 | 60 | 75 |
| | B3-3 | B4-1 | B4-2 | B5-1 | B5-2 | B6-1 | B6-2 | B6-3 |
| Methyl ethyl ketone | | 12.91% | 20.75% | 8.07% | 13.71% | 8.38% | 13.82% | 5.50% |
| Ethyl acetate | 51.55% | 63.67% | 41.33% | 65.48% | 42.45% | 64.73% | 42.96% | 64.77% |
| Desmodur ® RFE | 37.85% | 13.65% | 22.75% | 14.61% | 24.81% | 17.60% | 29.04% | 23.05% |
| Desmodur ® L 75 | 3.95% | 6.72% | | | | | | |
| Desmodur ® N 3300 | | 2.26% | 3.76% | | | | | |
| Vitel ® 2200B | 8.94% | 5.84% | 9.72% | 6.24% | 10.60% | 7.50% | 12.38% | 4.92% |
| TI | 1.11% | 1.12% | 1.12% | 1.10% | 1.15% | 1.21% | 1.22% | 1.18% |
| DBTL | 0.55% | 0.55% | 0.57% | 0.54% | 0.55% | 0.59% | 0.58% | 0.59% |
| Total | 100.00% | 100.00% | 100.00% | 100.00% | 100.00% | 100.00% | 100.00% | 100.00% |
| Carbon black | 10.07% | 10.39% | 10.10% | 10.05% | 10.04% | 10.08% | 9.94% | 10.24% |
| B | 9% | 5% | 9% | 6% | 11% | 4% | 7% | 6% |
| A | 8% | 5% | 9% | 6% | 10% | 7% | 11% | 4% |
| A + B | 17% | 11% | 18% | 12% | 20% | 11% | 18% | 10% |
| A/B | 0.87 | 0.98 | 0.98 | 0.90 | 0.90 | 1.58 | 1.58 | 0.79 |
| [NCO]/[OH] | 90 | 75 | 75 | 75 | 75 | 50 | 50 | 100 |

| | B6-4 | REF-1 | REF-2 | REF-3 | REF-4 | REF-5 | REF-6 |
|---|---|---|---|---|---|---|---|
| Methyl ethyl ketone | 9.17% | | | | | 85.20% | 77.02% |
| Ethyl acetate | 42.42% | 85.18% | | 77.04% | | | |
| Desmodur ® RFE | 38.44% | 11.28% | 96.50% | 11.27% | 88.33% | 11.27% | 11.25% |
| Desmodur ® L 75 | | | | | | | |
| Desmodur ® N 3300 | | | | | | | |
| Vitel ® 2200B | 8.21% | 2.04% | 2.01% | 10.18% | 10.16% | 2.04% | 10.14% |
| TI | 1.16% | 1.01% | 0.99% | 1.02% | 1.02% | 1.01% | 1.04% |
| DBTL | 0.59% | 0.50% | 0.50% | 0.49% | 0.49% | 0.49% | 0.55% |
| Total | 100.00% | 100.00% | 100.00% | 100.00% | 100.00% | 100.00% | 100.00% |
| Carbon black | 10.17% | | | | | | |
| B | 9% | 3% | 26% | 3% | 24% | 3% | 3% |
| A | 7% | 2% | 2% | 10% | 10% | 2% | 10% |
| A + B | 17% | 5% | 28% | 13% | 34% | 5% | 13% |
| A/B | 0.79 | 0.67 | 0.08 | 3.34 | 0.43 | 0.67 | 3.34 |
| [NCO]/[OH] | 100 | 118 | 1026 | 24 | 185 | 118 | 24 |

Test Methods

Application and Curing

The primer compositions were each applied as a coating to different metal automotive paint panels, using a brush. After a flash-off time of 30 minutes, the high-modulus polyurethane adhesive Sikaflex®-250 DM-2, or the low-modulus polyurethane adhesive SikaTack®-Ultrafast (both available commercially from Sika Schweiz AG), was applied as a circular bead using a cartridge press and a nozzle to the primed paint surface.

Subsequently the adhesive was cured for 7 days at 23° C. and 50% relative humidity (room-temperature climate storage: “CS”) and a third of the bead was tested by means of the adhesion test described below. Subsequently the sample was placed in water at 23° C. for a further 7 days (water storage: “WS”). Thereafter the adhesion was tested by the bead test for a further third of the bead. After that the specimen was subjected for a further 7 days in the case of the paints to a water condensation climate of 100% relative humidity and 40° C. (“WCS”) or in the case of the plastics to a hot and humid climate of 100% relative humidity and 70° C. (“HHS”), after which the adhesion of the final third of the bead was determined.

Paints

Metal panels with the following topcoat paint were used:

HDCT 4041 from PPG (“HDCT4041”)

RK 8046 from DuPont (“RK8046”)

RK4126 from DuPont (“RK4126”)

These paints have inadequate adhesion characteristics for one-component polyurethane adhesives without primer pre-treatment.

Adhesion Test (“Bead Test”)

The adhesion of the adhesive was tested by means of the ‘bead test’. In this test an incision is made at the end just above the adhesion face. The incised end of the bead is held with round-end tweezers and pulled from the substrate. This is done by carefully rolling up the bead on the tip of the tweezers, and placing a cut vertical to the bead pulling direction down to the bare substrate. The rate of bead removal is chosen so that a cut has to be made approximately every 3 seconds. The test length must amount to at least 8 cm. An assessment is made of the adhesive which remains on the substrate after the bead has been pulled off (cohesive fracture). The adhesion properties are evaluated by estimating the cohesive fraction of the adhesion face:
1=>95% cohesive fracture
2=>75-95% cohesive fracture
3=>25-75% cohesive fracture
4=<25% cohesive fracture
5=0% cohesion fracture (purely adhesive fracture)
   “P” in the evaluation denotes detachment of the primer from the substrate.

Test results with cohesive fracture values of less than 75% are considered inadequate.

Results

The adhesion results are compiled in Tables 2 and 3. On the one hand these tables show that for the primer compositions of the invention an improvement in the adhesion to critical paints is sharply improved. On the other hand, for example, from the comparison of B2-1, B2-2 and B2-3 with B3-1, B3-2 and B3-3, the advantageous effect of carbon black as a formulation additive in the primer compositions on the adhesion is also apparent.

The comparative examples REF-1 to REF-6 demonstrate, further, the importance of the stoichiometric ratio of the NCO groups to that of the OH groups and also of the weight ratio of polyester resin A to polyisocyanate B for the attainment of adhesion on critical paint substrates.

TABLE 2
Adhesion results of Sikaflex ®-250 DM-2 to different paints after different types of storage.

| | B1-1 | B1-2 | B1-3 | B2-1 | B2-2 | B2-3 | B3-1 | B3-2 | B3-3 | B4-1 | B4-2 |
|---|---|---|---|---|---|---|---|---|---|---|---|
| HDCT4041 | | | | | | | | | | | |
| CS | 5P | 5P | 5P | 5P | 5P | 5P | 1P | 1 | 1 | 4P | 4P |
| WS | 4P | 5 | 5 | 5P | 5P | 5P | 1 | 1 | 1 | 4P | 3P |
| WCS | 4P | 4P | 4P | 4P | 5P | 4P | 1 | 1 | 1 | 2P | 1P |
| RK8046 | | | | | | | | | | | |
| CS | 5P | 3P | 4 | 2P | 3P | 3P | 1P | 1 | 1 | 2P | 1 |
| WS | 5P | 5P | 5P | 4P | 5P | 5P | 1 | 1P | 1P | 2P | 1 |
| WCS | 5P | 5P | 5P | 5P | 5P | 5P | 1 | 2P | 2P | 2P | 1P |
| RK4126 | | | | | | | | | | | |
| CS | 5P | 4P | 4P | 4P | 3P | 1 | 1 | 2 | 1 | 1P | 1 |
| WS | 1 | 1 | 1 | 1 | 1 | 1 | 1 | 1 | 1 | 1 | 1 |
| WCS | 1 | 1 | 1 | 1 | 1 | 2P | 1 | 1 | 1 | 1 | 1 |
| ABS | | | | | | | | | | | |
| CS | 1 | 1 | 1 | 1 | 1 | 1 | n.m.* | n.m.* | n.m.* | 1 | 1 |
| WS | 1 | 1 | 1 | 1 | 1 | 1 | n.m.* | n.m.* | n.m.* | 1 | 1 |
| HHS | 1 | 1 | 1 | 1 | 1 | 1 | n.m.* | n.m.* | n.m.* | 1 | 1 |
| PMMA | | | | | | | | | | | |
| CS | 1 | 1 | 1 | 1 | 1 | 1 | n.m.* | n.m.* | n.m.* | 1 | 1 |
| WS | 1 | 1 | 1 | 1 | 1 | 1 | n.m.* | n.m.* | n.m.* | 1 | 2P |
| HHS | 1 | 1 | 1 | 1 | 1 | 1 | n.m.* | n.m.* | n.m.* | 1 | 1P |

| | B5-1 | B5-2 | B6-1 | B6-2 | B6-3 | B6-4 | REF-1 | REF-2 | REF-3 | REF-4 | REF-5 | REF-6 | REF-7 |
|---|---|---|---|---|---|---|---|---|---|---|---|---|---|
| HDCT4041 | | | | | | | | | | | | | |
| CS | 1P | 1P | 2P | 2P | 2P | 1P | 5 | 4P | 5P | 2P | 5 | 5 | 5 |
| WS | 1P | 1P | 3P | 2P | 2P | 1P | 5 | 5 | 5P | 5P | 5 | 5 | 5 |
| WCS | 1 | 1 | 5P | 5P | 5P | 5P | 5P | 5 | 5P | 5P | 5 | 5 | 5 |
| RK8046 | | | | | | | | | | | | | |
| CS | 1P | 1 | n.m.* | n.m.* | n.m.* | n.m.* | 5 | 4P | 5 | 2P | 5 | 5P | 5 |
| WS | 1P | 1P | n.m.* | n.m.* | n.m.* | n.m.* | 5 | 5 | 5 | 5P | 5 | 5 | 5 |
| WCS | 2P | 1P | n.m.* | n.m.* | n.m.* | n.m.* | 5 | 5P | 5 | 5P | 5 | 5 | 5 |
| RK4126 | | | | | | | | | | | | | |
| CS | 1 | 1 | n.m.* | n.m.* | n.m.* | n.m.* | 1 | 4P | 5P | 1 | 2 | 5P | 5 |
| WS | 1 | 1 | n.m.* | n.m.* | n.m.* | n.m.* | 3 | 5P | 5P | 5P | 5 | 5 | 5 |
| WCS | 1 | 1 | n.m.* | n.m.* | n.m.* | n.m.* | 3 | 4 | 5 | 5P | 5P | 5 | 5 |
| ABS | | | | | | | | | | | | | |
| CS | 5 | 1 | 3 | 1 | 5 | 1 | 4 | 1 | 1 | 1 | 5 | 2 | 5 |
| WS | 5 | 1 | 2 | 1 | 5 | 1 | 5 | 1 | 1 | 1 | 5 | 2 | 5 |
| HHS | 5 | 1 | 1 | 1 | 4 | 1 | 5 | 1 | 2 | 1 | 5 | 2 | 5 |
| PMMA | | | | | | | | | | | | | |
| CS | 1 | 1 | 1 | 1 | 1 | 1 | 1 | 1 | 1 | 1 | 1 | 1 | 5 |
| WS | 1 | 1 | 1 | 1 | 1 | 1 | 1 | 3P | 1 | 1P | 1 | 2 | 5 |
| HHS | 1 | 1 | 1 | 1 | 1 | 1 | 1 | 2P | 1 | 2P | 4 | 2 | 5 |

*n.m. = not measured.

TABLE 3
Adhesion results of SikaTack ®-Ultrafast to different paints after different types of storage.

| | B1-1 | B1-2 | B1-3 | B2-1 | B2-2 | B2-3 | B3-1 | B3-2 | B3-3 | B4-1 | B4-2 |
|---|---|---|---|---|---|---|---|---|---|---|---|
| HDCT4041 | | | | | | | | | | | |
| CS | 5P | 5P | 5P | 5P | 5P | 4P | 1 | 1 | 1 | 4P | 2P |
| WS | 5P | 5P | 5P | 5P | 5P | 5P | 1 | 1 | 1 | 4P | 2P |
| WCS | 4P | 5P | 4P | 3P | 4P | 4P | 1 | 1 | 1 | 2P | 1 |
| RK8046 | | | | | | | | | | | |
| CS | 2P | 2P | 2 | 2P | 3P | 2P | 1 | 1 | 2 | 2P | 1 |
| WS | 5P | 5P | 5P | 5P | 5P | 5P | 1 | 1 | 1 | 2P | 1 |
| WCS | 5P | 5P | 5P | 5P | 5P | 5P | 2P | 2P | 2P | 2P | 2P |
| RK4126 | | | | | | | | | | | |
| CS | 3P | 1 | 1 | 2 | 1 | 1 | 1 | 1 | 1 | 1 | 1 |
| WS | 1 | 1 | 1 | 1 | 1 | 1 | 1 | 2 | 1 | 1 | 1 |
| WCS | 1 | 1 | 1 | 2 | 2 | 2 | 1 | 1 | 1 | 1 | 1 |
| ABS | | | | | | | | | | | |
| CS | 1 | 1 | 1 | 1 | 1 | 1 | n.m.* | n.m.* | n.m.* | 1 | 1 |
| WS | 1 | 1 | 1 | 1 | 1 | 1 | n.m.* | n.m.* | n.m.* | 1 | 1 |
| HHS | 1 | 1 | 1 | 1 | 1 | 1 | n.m.* | n.m.* | n.m.* | 1 | 1 |
| PMMA | | | | | | | | | | | |
| CS | 1 | 1 | 1 | 1 | 1 | 1 | n.m.* | n.m.* | n.m.* | 1 | 2P |
| WS | 1 | 1 | 1 | 1 | 1 | 1 | n.m.* | n.m.* | n.m.* | 1 | 2P |
| HHS | 1 | 1 | 1 | 1 | 1 | 1 | n.m.* | n.m.* | n.m.* | 1 | 1 |

| | B5-1 | B5-2 | B6-1 | B6-2 | B6-3 | B6-4 | REF-1 | REF-2 | REF-3 | REF-4 | REF-5 | REF-6 | REF-7 |
|---|---|---|---|---|---|---|---|---|---|---|---|---|---|
| HDCT4041 | | | | | | | | | | | | | |
| CS | 1 | 1 | 1P | 1P | 2P | 1 | 5 | 5P | 5P | 4P | 5 | 5P | 5 |
| WS | 1P | 1P | 1P | 2P | 1P | 1 | 5 | 4 | 5P | 5P | 5 | 5 | 5 |
| WCS | 1 | 1 | 5P | 5P | 5P | 5P | 5P | 4 | 5P | 5P | 5 | 5 | 5 |
| RK8046 | | | | | | | | | | | | | |
| CS | 1P | 1 | n.m.* | n.m.* | n.m.* | n.m.* | 5 | 4P | 5 | 3P | 5 | 5P | 5 |
| WS | 1 | 1 | n.m.* | n.m.* | n.m.* | n.m.* | 5 | 5 | 5 | 5P | 5 | 5 | 5 |
| WCS | 1P | 2P | n.m.* | n.m.* | n.m.* | n.m.* | 5 | 5 | 5P | 5P | 5 | 5 | 5 |
| RK4126 | | | | | | | | | | | | | |
| CS | 1 | 1 | n.m.* | n.m.* | n.m.* | n.m.* | 1 | 2 | 5P | 1 | 1 | 5 | 5 |
| WS | 1 | 1 | n.m.* | n.m.* | n.m.* | n.m.* | 1 | 4P | 5P | 5P | 5 | 5 | 5 |
| WCS | 1 | 1 | n.m.* | n.m.* | n.m.* | n.m.* | 3 | 4P | 3 | 5P | 5P | 5 | 5 |
| ABS | | | | | | | | | | | | | |
| CS | 5 | 1 | 3 | 1 | 5 | 1 | 5 | 1 | 3 | 1 | 5 | 1 | 5 |
| WS | 5 | 1 | 2 | 1 | 5 | 1 | 5 | 1 | 3 | 1 | 5 | 2 | 5 |
| HHS | 5 | 1 | 2 | 1 | 5 | 1 | 5 | 1 | 3 | 1 | 5 | 1 | 5 |
| PMMA | | | | | | | | | | | | | |
| CS | 1 | 3 | 2 | 1 | 4 | 1 | 1 | 2 | 2 | 1 | 4 | 2 | 5 |
| WS | 1 | 3 | 2 | 1 | 5 | 1 | 1 | 3 | 2 | 1 | 4 | 2 | 5 |
| HHS | 1 | 4 | 2 | 1 | 2 | 1 | 1 | 3 | 3 | 1 | 5 | 2 | 5 |

*n.m. = not measured.

1. Primer composition comprising
at least one binder which contains isocyanate groups and is prepared from a mixture of an amorphous polyester resin A which is solid at room temperature and contains at least one OH group and of at least one polyisocyanate B of the formula (I), 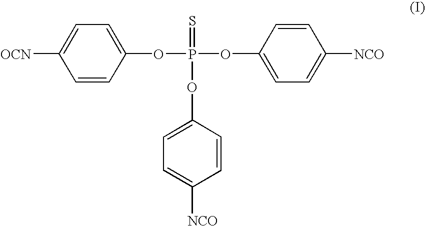
the solid polyester resin A and the polyisocyanate B being used in a ratio such that the stoichiometric ratio of the NCO groups to the OH groups is situated in the range between 50:1 and 100:1 and/or the weight ratio of polyester resin A to polyisocyanate B has a value of between 1.6 and 0.75, in particular between 1.2 and 0.8.

2. Primer composition according to claim 1, wherein the polyester resin A is preparable from at least one dicarboxylic acid and at least one glycol.

3. Primer composition according to claim 1, wherein the polyester resin A at 25° C. has a Shore D hardness of between 70 and 85, in particular between 77 and 82.

4. Primer composition according to claim 1, wherein the polyester resin A has an OH number of between 3 and 6 mg/KOH.

5. Primer composition according to claim 1, wherein the primer composition further comprises at least one organic solvent, in particular an ester, preferably ethyl acetate.

6. Primer composition according to claim 5, wherein the primer composition comprises at least two organic solvents, in particular ethyl acetate and at least one further organic solvent, in particular a ketone, preferably methyl ethyl ketone.

7. Primer composition according to claim 1, wherein the primer composition further comprises at least one carbon black.

8. Primer composition according to claim 7, wherein the amount of the carbon black is 1% to 20% by weight, in particular from 2% to 15% by weight, based on the weight of the primer composition.

9. Primer composition according to claim 1, wherein a fraction of the polyisocyanate B is replaced stoichiometrically by at least one polyisocyanate B′ and/or by at least one polyisocyanate B″ and/or by at least one polyisocyanate B′″, the polyisocyanate B′ being an isocyanurate of hexamethylene diisocyanate and the polyisocyanate B″ being an aromatic polyisocyanate based on tolylene diisocyanate and the polyisocyanate B′″ being an oligomeric polyisocyanate of hexamethylene 1,6-diisocyanate (HDI), diphenylmethane diisocyanate (MDI), isophorone diisocyanate (IPDI) and/or tolylene diisocyanate (TDI) or polymethylene polyphenyl isocyanate.

10. Primer composition according to claim 1, wherein fraction of the binder which is prepared from a mixture of the polyester resin A and from at least one polyisocyanate B is 10% to 50% by weight, in particular 15% to 30% by weight, based on the weight of the primer composition.

11. Use of a primer composition according to claim 1 as a primer for promoting the adhesion of adhesives or sealants to painted surfaces.

12. Use of a primer composition according to claim 1 as a primer for promoting the adhesion of adhesives or sealants to plastics, in particular to acrylonitrile-butadiene-styrene copolymers (ABS) or polymethyl methacrylate (PMMA).

13. Method of adhesive bonding or of sealing, comprising the steps of
a) applying a primer composition according to claim 1 to a first substrate S1 to be bonded or sealed
b) applying an adhesive or sealant to the flashed-off primer composition located on the substrate S1
c) contacting the adhesive or sealant with a second substrate S2; or
a′) applying the primer composition according to to a first substrate S1 to be bonded or sealed
b′) applying an adhesive or sealant to the surface of a second substrate S2, composed of the same or different material as the substrate S1,
c′) contacting the adhesive or sealant with the flashed-off primer composition which is located on the substrate S1; or
a″) applying the primer composition according to to a first substrate S1 to be bonded or sealed
b″) flashing off the primer composition
c′) applying an adhesive or sealant between the surfaces of the substrate S1 and S2,
the second substrate S2 being composed of the same or different material as the first substrate S1.

14. Method according to claim 13, wherein step c) or c′) or c″) is followed by a step d) of curing the adhesive or sealant.

15. Method according to claim 13, wherein the adhesive or sealant is a moisture-curing one-component polyurethane adhesive or sealant.

16. Method according to claim 13, wherein the substrate S1 is a paint, in particular a painted metal.

17. Bonded or sealed article obtained by a method according to claim 13.

18. Bonded or sealed article according to claim 17, wherein the article is a means of transport, in particular an automobile, or an externally mounted component of a means of transport, in particular of an automobile.
